(19) United States
(12) Patent Application Publication
(10) Pub. No.: US 2002/0095680 A1
(43) Pub. Date: Jul. 18, 2002

(54) Personal movie storage module

(76) Inventor: Robert J. Davidson, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/760,242

(22) Filed: Jan. 12, 2001

(51) Int. Cl. H04N 7/173

(52) U.S. Cl. 725/87

(57) ABSTRACT

A personal movie storage module allows an individual to select and store a movie into the module for later retrieval and viewing. The module includes an atomic resolution memory device and a communication interface. The memory device is capable of storing one or more movies while the communication interface permits writing to and reading from the memory device. Using the module, an individual can capture a packet of entertainment media, such as a movie from a purchase center, such as a kiosk in an airport. The movie is retrieved from the module at the individual's convenience using a media player (e.g., DVD-type player, notebook computer, etc.). In one embodiment, the memory device includes an atomic resolution storage device, which is subminiature in size, allowing it to be contained within a small housing, has low power requirements, and provides for non-volatile storage of large amounts of data, including video.

### CROSS REFERENCE TO RELATED APPLICATIONS

This Utility Patent Application is related to U.S. patent application entitled “PORTABLE INFORMATION STORAGE MODULE FOR INFORMATION SHOPPING” having Attorney Docket No. HP PDNO 10002307-1 filed herewith.

### THE FIELD OF THE INVENTION

The present invention relates generally to portable information storage and, in particular, to portable entertainment media storage devices.

### BACKGROUND OF THE INVENTION

With the widespread availability of entertainment media such as movies and music, consumers are growing accustomed to having complete choice in their entertainment. Unfortunately, in some venues, consumers remain a captive audience to entertainment choices made by other people. For example, those traveling long distances frequently travel by airplane. On longer flights, entertainment is provided by the airline in the form of music or movies. However, passengers have little or no say regarding the selection of the in-flight movie shown on board. Passengers experience a broad range of interest associated with the selected movie, ranging anywhere from complete boredom to staunch disinterest. Finally, these experiences with in-flight movies is generally extendable to other forms of travel such as train, automobile, ferry, etc.

The entertainment industry is constantly looking for more ways to make movies and music readily available. Easy access to desired entertainment media increases the profit made on a given movie or musical piece. Accordingly, given the immense demand, satisfying the desire for choice among weary travelers is ripe for exploitation.

### SUMMARY OF THE INVENTION

The present invention provides a personal movie storage module including a storage device having an atomic resolution storage device memory component capable of storing at least one movie. A communication interface communicates to and from the memory component of the storage module.

### BRIEF DESCRIPTION OF THE DRAWINGS

FIG. 1 is a schematic illustration of a personal movie storage module and an accompanying system of a movie playback device and a movie purchase center for use with the module, according to an embodiment of the present invention.

FIG. 2 is a schematic illustration of a movie library purchase center, according to an embodiment of the present invention.

FIG. 3 is a schematic illustration of a personal movie storage module, according to an embodiment of the present invention.

FIG. 4 is a side view illustrating one exemplary embodiment of a storage device used in a personal movie storage module in accordance with the present invention.

FIG. 5 is a simplified schematic diagram illustrating one exemplary embodiment of storing information within the storage device illustrated in FIG. 4.

FIG. 6 is a top view illustrating one exemplary embodiment of a storage device used in a personal movie storage module as shown in FIG. 4.

FIG. 7 is a diagram illustrating one exemplary embodiment of field emitters reading from storage areas of the storage device of FIG. 4.

FIG. 8 is schematic illustration of a portable movie storage module arranged in association with multiple playback devices and an alternative movie purchase source, according to an embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

A personal movie storage module of the present invention allows an individual to purchase and store a movie into the module for later retrieval and viewing. The module includes a high capacity memory device and a communication interface. The memory device is capable of storing one or more movies while the communication interface facilitates communicating to and from the memory device at a high transfer rate.

In one example embodiment, using the module, an individual can capture a packet of entertainment media, such as a movie from a purchase center, such as a kiosk in an airport. The movie is viewed from the module at the individual's convenience using a personal playback device (e.g., DVD-type player, notebook computer, etc.). This feature enables the individual to select what movie they want to watch, and then view that movie at their discretion, thereby permitting a traveler autonomy in selecting their entertainment while traveling.

In one preferred embodiment, the memory device includes an atomic resolution storage device. Alternatively, the memory device optionally another suitable high capacity storage device. The atomic resolution storage device used in the personal movie storage module according to the present invention is subminiature in size, allowing it to be contained within a small housing, has low power requirements, and provides for non-volatile storage of large amounts of data, including video. The term “atomic resolution storage device” memory as used herein is defined as a non-volatile memory storage device capable of storing a large volume of data, such as megabytes to gigabytes of data points, within a relatively small storage area and requiring very low power consumption. The atomic resolution storage device includes a field emitter, a storage medium, and a micromover and associated circuitry for the reading and writing of data. Preferably, the atomic resolution storage device includes a plurality of spaced apart field emitters, wherein each field emitter is responsible for a number of storage areas on the storage medium.

A personal movie storage module 10 of the present invention is shown generally in FIG. 1 along with movie purchase center 12 (e.g., a kiosk in an airport), central movie database 14, and personal playback device 16. Together, these elements form a system of purchasing a movie, storing and transporting the movie, and viewing the movie, with all of these acts performed at the discretion of the consumer.

Purchase center 12 further includes video display 20, keypad 22, and slots 24 for receiving personal movie storage module while playback device 16 further includes video display 26, audio component 28 and slot 30 for receiving personal movie storage module 10.

Purchase center 12 preferably is available at a shopping center, airport, or other public venue, and hosts a large selection of audio and video formats of books, music, movies and/or other entertainment media for purchase via module 10. For example, a user could purchase a movie from purchase center 12 using a credit card and store the movie in personal movie storage module 10. In particular, using display 20 and keypad 22 of purchase center 12, the user purchases one or more selections of an entertainment media (e.g., a movie). A copy of that selection is transferred from purchase center 12 (e.g., downloaded) via communication slot 24 for storage into personal movie storage module 10. The selection is preferably downloaded in a broadband communication format from central movie database 14.

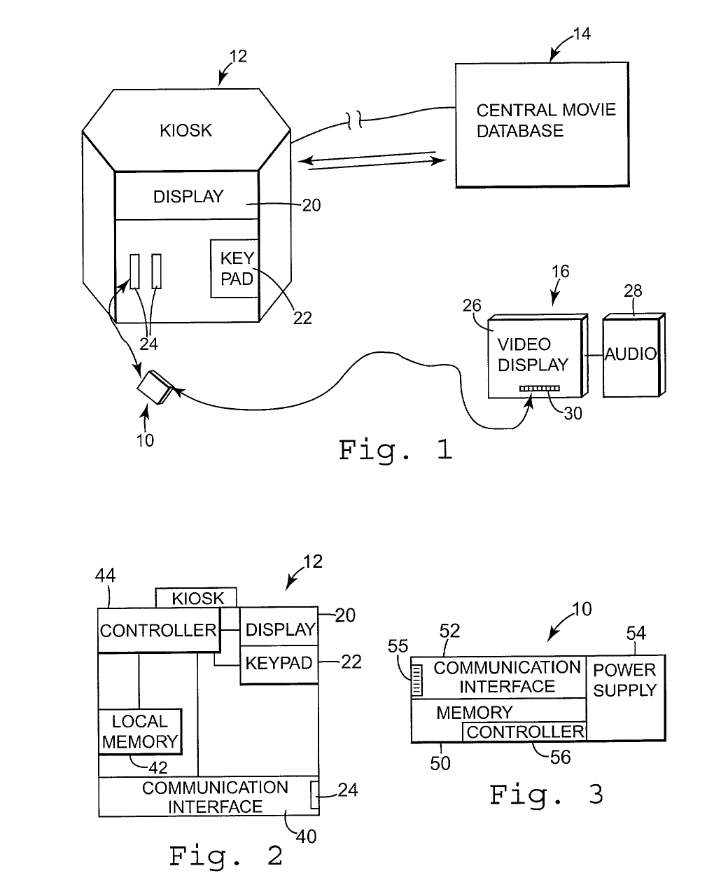

FIG. 2 is a schematic illustration of purchase center 12. As shown in FIG. 2, purchase center 12 includes previously identified display 20, keypad 22, slot 24 and also further includes communication interface 40, local memory 42, and controller 44. Video display 20 provides information about the selection of available movies, pricing, and order status. Display 20 also can provide previews of movies to attract consumer interest. Keypad 22 permits the user to select a movie and complete a purchase of the movie. Keypad 22 optionally includes a known credit card point of purchase device. Communication interface 40 governs communication between purchase center 12 and module 10 as well as between purchase center 12 and central movie database 14. As previously shown in FIG. 1, purchase center 12 (e.g., kiosk) is in broadband communication with central movie database 14. Finally, local memory 42 permits on-site storage of some movies, menus of selectable movies, pricing information, and purchasing programs. On-site storage of some movies is useful where purchase center 12 operates independently of central movie database or where some movies are ordered so frequently that those movies are stored locally in memory 42 of purchase center 12 to permit more direct downloading to module 10.

To use the system, the consumer approaches purchase center 12 (e.g. kiosk) and uses display 20 and keypad 22 to select a movie for purchase. The user places their personal movie storage module 10 into slot 24 of purchase center 12. Alternatively, purchase center 12 can provides a personal movie storage module 10 in slot 24 for purchase or rental by the consumer. Next, a selected movie is downloaded from central movie database 14 via purchase center 12 onto personal movie storage module 10. Since download times take more than a few minutes, purchase center 12 can offer personal movie storage modules 10 for sale that already have a movie stored on the module 10. Similarly, when the purchasing environment is an airport, the consumer can order a movie at the time they book their airline tickets and the airline would then provide the user with a personal movie storage module having the selected movie. In this latter case, purchase center 12 is bypassed altogether.

Once the desired movie is captured on personal movie storage module 10, the consumer inserts module 10 into slot 30 of personal playback device 16 for viewing the movie through video display 26 and audio portion 28. Playback device 16 is portable to allow viewing the movie almost anywhere and at anytime.

During purchase of the movie, purchase center 12 encodes personal movie storage module 10 with instructions to either allow unlimited viewing of the movie, or to limit viewing to a finite number of viewings or to a finite period of time (e.g. 24 hours). Of course, these procedures as well as other procedures known in the art can be implemented to protect intellectual property (e.g., copyright) in the movie and to insure a secure correlation between the purchase price and the number of viewings.

Finally, personal movie storage module 10 has an extremely large memory, as will be further described later in this application. Accordingly, more than one movie can be stored in module 10 at one time and this type of memory permits repeated storage of movies. In one example, after a limited-viewing movie no longer can be viewed, this movie is deleted from module 10 upon the next instance that personal movie storage module 10 is placed in purchase center 12. This feature permits the consumer to reuse module 10 while the owners of the purchase center and owners of the copyright can regulate pricing and security.

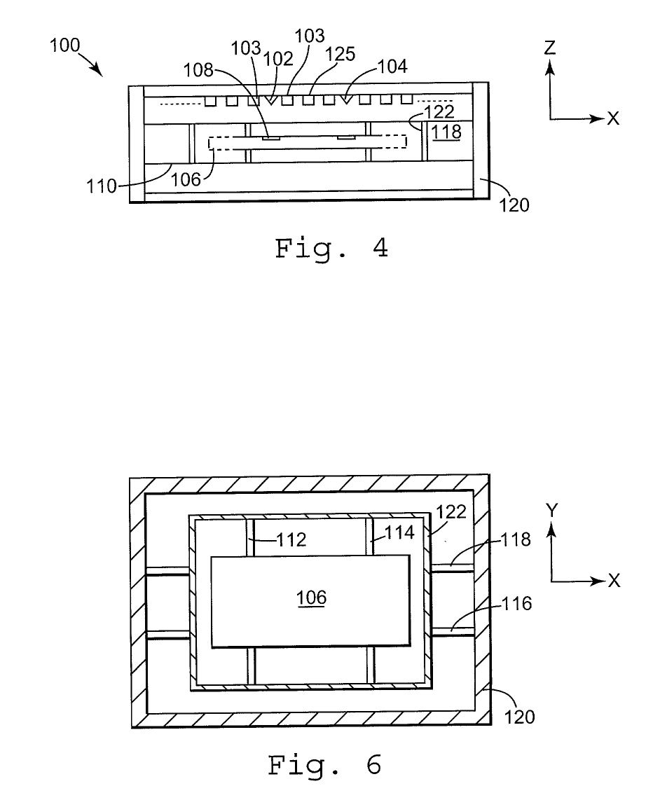

FIG. 3 is a schematic illustration of module 10 showing further details about module 10. Module 10 further includes memory 50, communication interface 52, and power supply 54. Communication interface 50 includes connector 55. Communication interface 50 permits communication between module 10 and purchase center 12 and between module 10 and playback device 16. Connector 55 is in electrical communication with communication interface 52 and preferably includes an array of contact pins for establishing coupled communication with slot 24 of purchase center 12 and/or with slot 30 of playback device 16.

Memory 50 of personal movie storage module 10 further includes optional controller 56 for facilitating control of module 10 and/or of other devices used in association with module 10. Memory or storage device 50 of module 10 is preferably a high capacity storage device, and which is more preferably of a silicon-based construction. In one preferred embodiment, memory 50 is an atomic resolution storage (ARS) device capable of storing a large volume of data, such as megabytes to gigabytes of data points, within a relatively small storage area. The atomic resolution storage device is a low power consumption storage device. In one embodiment, the atomic resolution storage device requires less than 500 mW to operate. In one preferred embodiment, the ARS device of memory 50 has a size of about 1 square millimeter, suitable to be carried within the personal movie storage module 10. In addition, ARS module can include its own modules that correspond to the functions of optional logic controller 56. Finally, other subminiature memory devices, known to those skilled in the art, that have a high storage capacity with relatively low power consumption can be used in place of ARS module. However, these alternative devices may limit the volume and quality of data recorded since these devices will not be as beneficial as ARS module of memory 50 relative to the power consumption requirements and amount of memory storage.

One atomic resolution storage device suitable for use in portable entertainment media module according to the present invention is disclosed in U.S. Pat. No. 5,557,596 to Gibson et al., issued Sep. 17, 1996, entitled “Ultra-High Density Storage Device.” Other suitable high density storage devices suitable for use as memory 50 with personal movie storage module according to the present invention will become apparent to those skilled in the art after reading the present application. One exemplary embodiment of a suitable high density storage device (i.e., atomic resolution storage device) suitable for use as memory 50 with personal movie storage module according to the present invention is disclosed in further detail later in this application. Memory 50 is especially suitable for storing many different types of entertainment media such as books, music, movies, etc. The entertainment media can be pre-loaded onto memory 50 so that a purchase of module 10 already includes the desired entertainment media, e.g. a music CD or book. Alternatively, module 10 can be used to capture and store the desired entertainment media by choosing the desired selection from purchase center 12 and transferring a copy of the selection into memory 50 of module 10 for later retrieval with playback device 16. Since memory 50 is so large, multiple entertainment media are loadable into memory 50, thereby permitting repeated use of module 10.

FIGS. 4 through 7 disclose one exemplary embodiment of an atomic resolution storage device of memory 50 capable of storing megabytes to gigabytes of information in a small storage area. For a further discussion of an atomic resolution storage device, see U.S. Pat. No. 5,557,596, entitled, “Ultra-High Density Storage Device”, by Gibson et al. and assigned to Hewlett-Packard Company, which is incorporated herein by reference.

FIG. 4 illustrates a side cross-sectional view of storage device 100. Storage device 100 is one exemplary embodiment of memory 50 of personal movie storage module 10. Storage device 100 includes a number of field emitters, such as field emitters 102 and 104, storage medium 106 including a number of storage areas, such as storage area 108, and micromover 110. Micromover 110 scans storage medium 106 with respect to the field emitters or vice versa. In one preferred embodiment, each storage area is responsible for storing one bit of information.

In one embodiment, the field emitters are point emitters having relatively very sharp points. Each point emitter may have a radius of curvature in the range of approximately 1 nanometer to hundreds of nanometers. During operation, a pre-selected potential difference is applied between a field emitter and its corresponding gate, such as between field emitter 102 and gate 103 surrounding it. Due to the sharp point of the emitter, an electron beam current is extracted from the emitter towards the storage area. Depending on the distance between the emitters and the storage medium 106, the type of emitters, and the spot size (bit size) required, electron optics may be utilized to focus the electron beams. A voltage may also be applied to the storage medium 106 to either accelerate or decelerate the field-emitted electrons or to aid in focusing the field-emitted electrons.

In one embodiment, casing 120 maintains storage medium 106 in a partial vacuum, such as at least 10⁻⁵ torr. It is known in the art to fabricate such types of microfabricated field emitters in vacuum cavities using semiconductor processing techniques. See, for example, “Silicon Field Emission Transistors and Diodes,” by Jones, published in IEEE Transactions on Components, Hybrids and Manufacturing Technology, 15, page 1051, 1992.

In the embodiment shown in FIG. 4, each field emitter has a corresponding storage area. In another embodiment, each field emitter is responsible for a number of storage areas. As micromover 110 scans storage medium 106 to different locations, each emitter is positioned above different storage areas. With micromover 110, an array of field emitters can scan over storage medium 106.

As will be described, the field emitters are responsible to read and write information on the storage areas by means of the electron beams they produce. Thus, field emitters suitable for use in storage device 100 are the type that can produce electron beams that are narrow enough to achieve the desired bit density on the storage medium, and can provide the power density of the beam current needed for reading from and writing to the medium. A variety of ways are known in the art that are suitable to make such field emitters. For example, one method is disclosed in “Physical Properties of Thin-Film Field Emission Cathodes With Molybdenum Cones,” by Spindt et al, published in the Journal of Applied Physics, Vol. 47, No. 12, December 1976. Another method is disclosed in “Fabrication and Characteristics of Si Field Emitter Arrays,” by Betsui, published in Tech. Digest 4^{th} Int. Vacuum Microelectronics Conf., Nagahama, Japan, page 26, 1991.

In one embodiment, there can be a two-dimensional array of emitters, such as 100 by 100 emitters, with an emitter pitch of 50 micrometers in both the X and the Y directions. Each emitter may access tens of thousands to hundreds of millions of storage areas. For example, the emitters scan over the storage areas with a periodicity of about 1 to 100 nanometers between any two storage areas. Also, all of the emitters may be addressed simultaneously or sequentially in a multiplexed manner. Such a parallel accessing scheme significantly reduces access time, and increases data rate of the storage device.

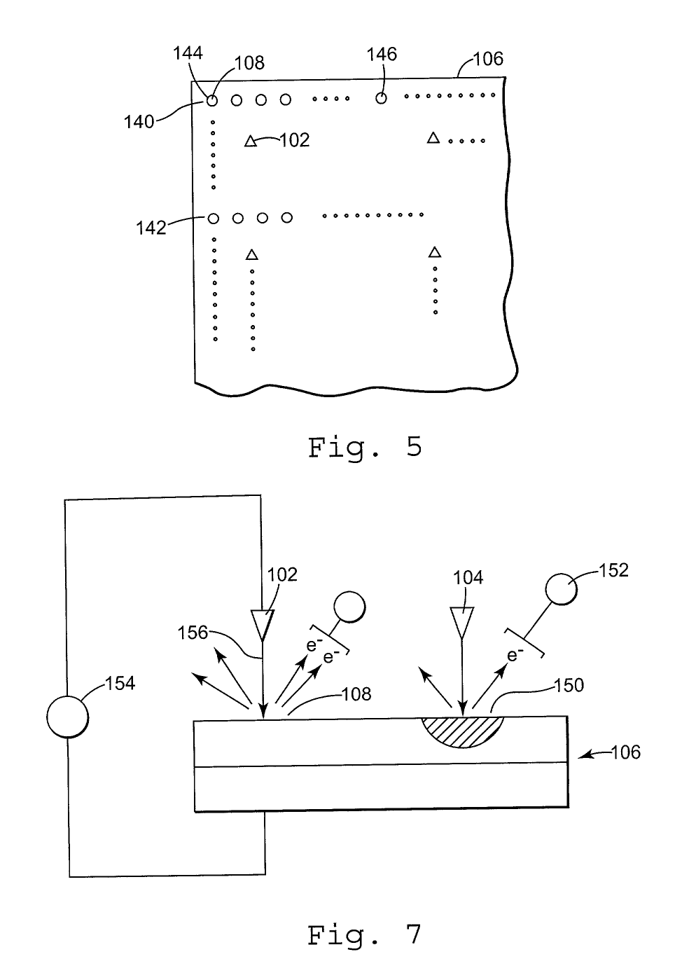

FIG. 5 shows the top view of storage medium 100 having a two-dimensional array of storage areas and a two-dimensional array of emitters. Addressing the storage areas requires external circuits. One embodiment to reduce the number of external circuits is to separate the storage medium into rows, such as rows 140 and 142, where each row contains a number of storage areas. Each emitter is responsible for a number of rows. However, in this embodiment, each emitter is not responsible for the entire length of the rows. For example, emitter 102 is responsible for the storage areas within rows 140 through 142, and within columns 144 through 146. All rows of storage areas accessed by one emitter are connected to one external circuit. To address a storage area, one activates the emitter responsible for that storage area and moves that emitter by means of the micromover 110 (shown in FIG. 4) to that storage area. The external circuit connected to the rows of storage areas within which that storage area lies is activated.

Micromover 110 can also be fabricated in a variety of ways, as long as it has sufficient range and resolution to position the field emitters over the storage areas. As a conceptual example, micromover 110 is fabricated by standard semiconductor microfabrication process to scan storage medium 106 in the X and Y directions with respect to casing 120.

FIG. 6 shows the top view of the storage medium 106, (shown in FIG. 4) held by two sets of thin-walled microfabricated beam-like structural members, 112, 114, 116, 120. The faces of the first set of thin-walled beams are in the Y-Z plane, such as 112 and 114. Thin-walled beams 112 and 114 may be flexed in the X direction allowing storage medium 106 to move in the X direction with respect to casing 120. The faces of the second set of thin-walled beams are in the X-Z plane, such as 116 and 118. Thin-walled beams 116 and 118 allow storage medium 106 to move in the Y direction with respect to casing 120. Storage medium 106 is held by the first set of beams, which are connected to frame 122. Frame 122 is held by the second set of beams, which are connected to casing 120. The field emitters scan over storage medium 106, or storage medium 106 scans over the field emitters in the X-Y directions by electrostatic, electromagnetic, piezoelectric, or other means known in the art. In this example, micromover 110 moves storage medium 106 relative to the field emitters. A general discussion of such microfabricated micromover can be found, for example, in “Novel Polysilicon Comb Actuators for XY-Stages,” published in the Proceeding of MicroElectro Mechanical Systems 1992, written by Jaecklin et al.; and in “Silicon Micromechanics: Sensors and Actuators on a Chip”, by Howe et al., published in IEEE Spectrum, page 29, in July 1990.

In another embodiment, electron beams are scanned over the surface of storage medium 106 by either electrostatically or electromagnetically deflecting them, such as by electrostatic deflectors or electrodes 125 (shown in FIG. 4) positioned adjacent to emitter 104. Many different approaches to deflect electron beams can be found in literature on Scanning Electron Microscopy and will not be further described in this specification.

In one method, writing is accomplished by temporarily increasing the power density of the electron beam current to modify the surface state of the storage area. Reading is accomplished by observing the effect of the storage area on the electron beams, or the effect of the electron beams on the storage area. For example, a storage area that has been modified can represent a bit 1, and a storage area that has not been modified can represent a bit 0, and vice versa. In fact, the storage area can be modified to different degrees to represent more than two bits. Some modifications may be permanent, and some modifications may be reversible. The permanently modified storage medium is suitable for write-once-read-many memory (WORM).

In one embodiment, the basic idea is to alter the structure of the storage area in such a way as to vary its secondary electron emission coefficient (SEEC), its back-scattered electron coefficient (BEC), or the collection efficiency for secondary or back-scattered electrons emanating from the storage area. The SEEC is defined as the number of secondary electrons generated from the medium for each electron incident onto the surface of the medium. The BEC is defined as the fraction of the incident electrons that are scattered back from the medium. The collection efficiency for secondary/back-scattered electrons is the fraction of the secondary/back-scattered electrons that is collected by an electron collector, typically registered in the form of a current.

Reading is typically accomplished by collecting the secondary and/or back-scattered electrons when an electron beam with a lower power density is applied to storage medium 106. During reading, the power density of the electron beam should be kept low enough so that no further writing occurs.

One embodiment of storage medium 106 includes a material whose structural state can be changed from crystalline to amorphous by electron beams. The amorphous state has a different SEEC and BEC than the crystalline state, which leads to a different number of secondary and back-scattered electrons emitted from the storage area. By measuring the number of secondary and back-scattered scattered electrons, one can determine the stage of the storage area. To change from the amorphous to crystalline state, one increases the beam power density and then slowly decreases it. This heats up the amorphous and then slowly cools it so that the area has time to anneal into its crystalline state. To change from crystalline to amorphous state, one increases the beam power density to a high level and then rapidly decreases the beam power. To read from the storage medium, a lower-energy beam strikes the storage area. An example of such type of material is germanium telluride (GeTe) and ternary alloys based on GeTe. Similar methods to modify states using laser beams as the heating source have been described in “Laser-induced Crystallization of Amorphous GeTe: A Time-Resolved Study,” by Huber and Marinero, published in Physics Review B 36, page 1595, in 1987, and will not be further described here.

There are many preferred ways to induce a state change in storage medium 106. For example, a change in the topography of the medium, such as a hole or bump, will modify the SEEC and BEC of the storage medium. This modification occurs because the coefficients typically depend on the incident angle of the electron beam onto the storage area. Changes in material properties, band structure, and crystallography may also affect the coefficients. Also, the BEC depends on an atomic number, Z. Thus, one preferred storage medium has a layer of low Z material on top of a layer of high Z material or vice versa, with writing accomplished through ablating some of the top layer by an electron beam.

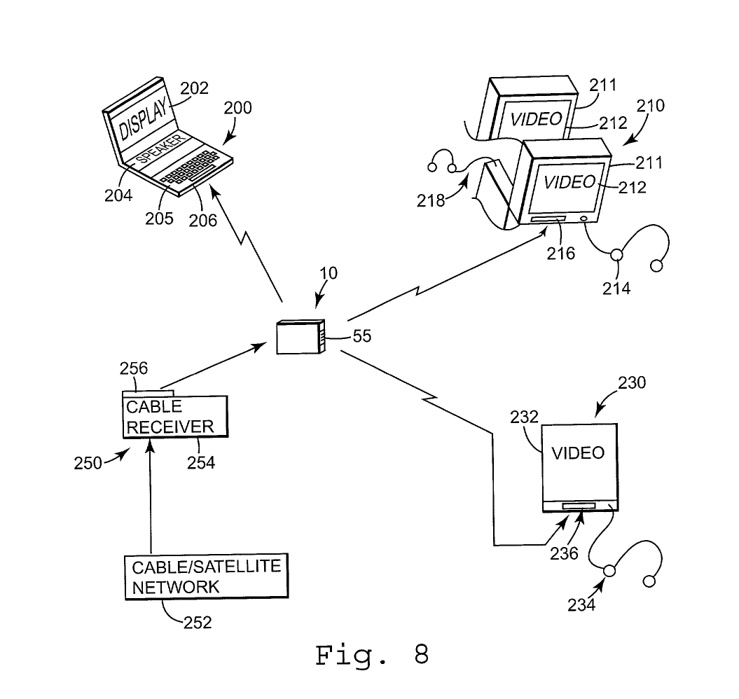

FIG. 7 shows schematically the field emitters reading from storage medium 106. The state of storage area 150 has been altered, while the state of storage area 108 has not been altered. When electrons bombard a storage area, both secondary electrons and back-scattered electrons will be collected by the electron collectors, such as electron collector 152. An area that has been modified will produce a different number of secondary electrons and back-scattered electrons, as compared to an area that has not been modified. The difference may be more or may be less depending on the type of material and the type of modification. By monitoring the magnitude of the signal current collected by electron collectors 152, one can identify the state of and, in turn, the bit stored in, the storage area.

Field emitters may be noisy with the magnitude of the electron beam current varying with respect to time. Moreover, the gap distance between the tips of the emitters and the surface of the storage medium may vary. If the information stored were based on tunneling current, then the gap distance may be extremely crucial. However, the application presently disclosed depends on field emitters, and not directly on the emitted electron beam current, but rather on the effect of the beam. At least two ways may be used to alleviate the problem of the emitters being noisy. One way is to connect constant current source 154 to field emitter 102. This source will control the power density of electron beam current beam 156. Although this method would not help storage techniques using the magnitude of the field emitted current as the signal, this method reduces the field emitter noise significantly. Another way to alleviate the field-emitter noise is to separately measure the emitted electron beam current and use it to normalize the signal current. As the electron beam current varies, the signal current varies correspondingly. On the other hand, the normalized signal current remains the same to indicate the state of the storage area.

As shown in FIG. 8, additional playback devices for use with personal movie storage module 10 of the present invention comprise notebook computer 200, seatback viewer 210, personal movie player 230.

Among other well known features of notebook computer 200 such as video display 202, audio speaker 204, keypad 205, computer 200 also includes slot 206 for receiving personal movie storage module 10. Seatback player system 210 includes seatback 211, video display 212, audio headset 214, slot 216 for receiving personal movie storage module 10, and optional armrest audio supply 218. Finally, personal playback device 230 further includes video display 232, audio headset 234, and slot 236 for receiving personal movie storage module 10.

Since many consumers of entertainment media already have notebook computers (or even desktop computers), entertainment media stored on module 10, such as a movie, can be enjoyed using notebook computer 200. For example, a movie stored in personal movie storage module 10 is viewed in display 202 and heard in speakers 204 of computer 200 while keypad 205 is used to manipulate display 202, speakers 204 and/or operation of module 10. Using known voice recognition technology, microphone 203 optionally is used to control these functions and components. Slot 206 comprises an industry standard communication pathway to permit memory 50 of personal movie storage module 10 to communicate with the identified components and functions of notebook computer 200.

Personal movie storage module 10 is ideal for use in the travel industry. Accordingly, various types of transportation which include multiple person seating will incorporate playback systems into their seating. For example, as shown in FIG. 8, an airplane, commuter train, and minivan, as well as other transportation modes can include seats having a seatback player 210 built into the back of every seat. Accordingly, once the traveler is seated, personal movie storage module 10 is placed in slot 216 and played for viewing on video display 212 mounted on seatback 211 (e.g. stationed in front of the seated traveler) and listened to with audio headset 214 extending from seatback 211. Alternatively, audio headset 214 can extend from arm rest audio supply 218. The convenience of seatback-type playback devices will enable a consumer to use personal movie storage module 10 for viewing movies without having to bring their own personal playback device or to purchase a personal playback device.

Finally, personal playback device 230 is available for those wanting a dedicated portable device for viewing movies stored on personal movie storage module 10. In use, module 10 is placed in slot 236 to permit a controller and communication interface (not shown) in personal playback device 230 to display the movie on video display 232 and audio headset 234. Personal playback device 230 can be embodied in a conventional DVD movie player, or in a stand alone device independent of the DVD format.

Finally, FIG. 8 also shows a home point-of-purchase system 250 that can be used to select and download movies onto personal movie storage module 10. Home point-of-purchase system 250 includes cable/satellite/internet network 252 and cable receiver 254 with slot 256 for communicating with and for receiving personal movie storage module 10. In this use of personal movie storage module 10, a movie is purchased through a known pay-per-view system available through network 252 and downloaded into personal storage module 10 via receiver 254. After the movie is downloaded, the consumer removes personal movie storage module 10 from slot 256 of receiver 254 and takes module 10with them for later viewing with a personal playback device 16. This allows the consumer to select and obtain their movie at their leisure before embarking on their journey.

A personal movie storage module of the present invention carries many advantageous features. Foremost, the module includes a high capacity memory component for storing large amounts of information such as movies, etc. in an extremely small space. This feature permits conveniently transporting an entertainment packet (e.g a movie) in a virtually hands-free and almost weightless manner relative to transporting conventional formats such as a DVD. In addition, with the use of personal playback devices that are portable or built into the environment, the movie can be viewed at the consumer's discretion. The memory component of the module also can be re-used so that the module need not be thrown away after a single use. Finally, in the eyes of the entertainment-consuming individual, a personal movie storage module of the present invention enables the individual to have complete choice over what movies they watch and when they watch them while traveling.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of portably handling a movie comprising:
storing electronically readable movie into a personal movie storage module including an atomic resolution storage memory component; and
recalling selectively the movie from the memory component of the personal storage module into a personal movie playback device for viewing by a user.

2. The method of claim 1, wherein the storing step further includes:
transferring a copy of the movie from a movie purchase center into the memory component of the personal storage module.

3. The method of claim 2 and the transferring step further comprising:
downloading the movie from a remotely located centralized movie database.

4. The method of claim 1 and further comprising:
repeating the storing step to capture additional electronically readable movies into the memory component of the storage module.

5. The method of claim 1 wherein the recalling step further comprises the playback device including at least one of a notebook computer, a personal movie player, and a seatback-mounted movie viewer.

6. The method of claim 1 wherein, the storing step further comprises:
providing the storage module with a communication interface, and a power supply.

7. The method of claim 1 wherein the memory component further includes a controller logic for operating the storage device and communicating between the memory component and the communication interface.

8. The method of claim 1 and further comprising:
performing the storing step and the recalling step in a broadband frequency format.

9. A personal movie storage module comprising:
a storage device including an atomic resolution storage device memory component capable of storing at least one movie; and
a communication interface for communicating to and from the memory component of the storage module.

10. The module of claim 9, and further comprising a controller unit located on the atomic resolution storage device for operating the storage device and communicating between the memory component and the communication interface.

11. The module of claim 9, wherein the atomic resolution storage device further comprises:
a field emitter fabricated by semiconductor microfabrication techniques capable of generating an electron beam current; and
a storage medium in proximity to the field emitter and having a storage area in one of a plurality of states to represent the information stored in the storage area.

12. The module of claim 11, wherein an effect is generated when the electron beam current bombards the storage area, wherein the magnitude of the effect depends upon the state of the storage area, and wherein the information stored in a storage area is read by measuring the magnitude of the effect.

13. The module of claim 11, further comprising:
a plurality of storage areas on the storage medium, with each storage area being similar to the one recited in claim 11; and
a microfabricated mover in the storage device to position different storage areas to be bombarded by the electron beam current.

14. The module of claim 13, further comprising:
a plurality of field emitters, with each emitter being similar to the one recited in claim 11, the plurality of field emitters being spaced apart, with each emitter being responsible for a number of storage areas on the storage medium; and
such that a plurality of the field emitters can work in parallel to increase the data rate of the storage device.

15. The module of claim 9 further comprising:
a housing which encloses the ultra-high capacity storage device and the communication interface.

16. A portable movie handling system comprising:
a portable movie storage module comprising:
an atomic resolution storage memory device of storing at least one movie; and
a communication interface for communicating to and from the storage device;
a purchase system permitting purchasable access to movies stored as electronically readable information including:
a centralized movie database storing a collection of movies for downloading to multiple points-of purchase; and
a point-of-purchase center for selectively transferring a copy of a selected movie from the centralized database to the memory device of the movie storage module; and
a movie playback device for viewing movie from the storage memory device of the movie storage module.

17. The system of claim 15 wherein the playback device is at least one of a notebook computer, a seatback mounted movie viewer, and a personal portable playback device.

18. The system of claim 15 wherein the centralized movie database comprises a cable/satellite TV network and the point-of-purchase center comprises a cable/satellite TV receiver.
